(19) United States
(12) Patent Application Publication
(10) Pub. No.: US 2012/0269259 A1
(43) Pub. Date: Oct. 25, 2012

(54) System and Method for Encoding VBR MPEG Transport Streams in a Bounded Constant Bit Rate IP Network

(76) Inventors: Mark Sauer, Bragg Creek (CA); Robert D. Saunders, Alpharetta, GA (US)

(21) Appl. No.: 13/275,297

(22) Filed: Oct. 17, 2011

Related U.S. Application Data
(60) Provisional application No. 61/393,759, filed on Oct. 15, 2010.

(51) Int. Cl. H04N 7/26

(52) U.S. Cl. 375/240.02; 375/E07.154

(57) ABSTRACT

Various embodiments of methods and systems for buffering a video stream to smooth out the variable bit rate in an MPEG 2 transport stream to a capped bit rate, while not causing packet loss on the network, and allowing the streams to pass through a bit rate constrained IP network are disclosed. One method includes conditioning a variable bit rate video content stream such that the frames are packed back to back into a constant bit rate stream such that filler packets are not required to approximate a constant bit rate. The packed video content stream, having a constant bit rate due to portions of the frames being packed into a given transmission segment, may be transmitted across a channel in a constant bit rate network.

### CROSS-REFERENCE TO RELATED APPLICATIONS

Priority under 35 U.S.C.§119(e) is claimed to the U.S. provisional application entitled “SYSTEM AND METHOD FOR ENCODING VBR MPEG TRANSPORT STREAMS IN A BOUNDED CONSTANT BIT RATE IP NETWORK,” filed on Oct. 15, 2010 and assigned application Ser. No. 61/393,759, the entire contents of which are hereby incorporated by reference.

### DESCRIPTION OF THE RELATED ART

Internet protocol (“IP”) networks, such as provided by Asymmetric Digital Subscriber Line (“ADSL”) internet connections, have a fixed upper bound on the transmission speed (i.e., transmission rate) that can be realized. Compressed video signals are very variable by their nature.

Video standards such as, but not limited to, H.264, H.263, MPEG-2, MPEG-4 and others compress video content by encoding a group of pictures (“GOP”). The first picture in a GOP sequence is compressed as a still image using only redundancies within the image to achieve a reduction in the bits needed to represent the image. This first picture in a GOP is often referred to as an “I” frame. The second and subsequent pictures in the GOP sequence, as compared to the “I” frame, can be further compressed by taking advantage of the redundancies between the previously encoded pictures and the current picture—regions of the picture often have the same background, or objects move location. Consequently, by coding differences from the previous frames the pictures subsequent to the “I” frame can be significantly smaller. These subsequent pictures are known as “P” frames for predicted frames. Moreover, “B” frames (or bi-directionally predicted frames) are similar to P frames, except they involve coding pictures in the GOP out of order, and using the information in two (or more) frames to predict regions of the current frame to achieve even better compression.

The result of video compression according to the above described method is that the bits assigned per frame can vary quite a bit, with the “I” frame containing the most bits as compared to the P/B frames. This creates a variable bit rate (“VBR”) transmission stream as the “I” frame puts out its large number of bits over 1/f of a second (where f represents the frame rate of the video), while the P/B frames put out their bits over the same interval.

Because a compressed video stream is transmitted on a variable bit rate, video encoders may use a rate control algorithm to condition the stream for transmission across a constant bit rate (“CBR”) network. The rate control algorithm essentially modifies the VBR video stream such that it becomes a CBR video stream. One CBR conditioning algorithm seeks to even out the peaks and troughs in a VBR stream over a period of time (e.g., 1 or 2 seconds) such that the resulting video stream has a bit rate that does not exceed a threshold over a given time interval. Notably, even though the peaks and troughs may have been conditioned by the algorithm, the stream may still have a variable bit rate from frame to frame in a GOP, when viewed over small intervals of time. Such bit rate variability, even though minimal after conditioning, can make the stream susceptible to packet loss when transmitted across a constrained network (i.e., CBR network).

Another CBR conditioning algorithm simply seeks to modify each frame in a VBR stream such that all the frames are the same size. Notably, in many cases such an approach can cause the “I” frame to be compressed too much, destroying video quality, and the subsequent P/B frames to exhibit a higher quality than is necessary, thereby wasting many bandwidth.

Of the two CBR algorithms described above, the first algorithm is moderately flexible in that it may generate a conditioned stream that has decent visual quality, without incurring too much of a bit cost in wasted bandwidth. The second algorithm may be more inefficient in conditioning a VBR stream in that the resulting stream may either require an excessive peak bit rate to transmit the video at an acceptable quality or the video quality may suffer so that the constant bit rate stream may fit into the bit rate target allowed by CBR network.

A third CBR conditioning methodology first “muxes” together a video stream with an associated audio stream (which incidentally may not exhibit the same variable bit rate nature as the video stream) to produce an Mpeg 2 Transport stream (or any type of video container for that matter) having a variable bit rate. To condition the stream to a constant bit rate, filler packets may be added to various frames within a given GOP so that the final bit rate of the video stream is perfectly constant. Whether an “I” frame, “P” frame or “B” frame, the filler packets are added to take up bandwidth and “smooth out” the otherwise variable bit rate. Notably, such a CBR conditioning methodology, while producing a true CBR video stream, necessarily wastes valuable bandwidth by transmitting filler packets that are not required for any purpose other than CBR conditioning.

Current systems and methods for conditioning a VBR video content stream for transmission across a CBR network either waste bandwidth or risk packet loss. Accordingly, what is needed in the art is a system and method for packing VBR video content stream into a CBR stream without using filler packets or exceeding bit rate limits.

### SUMMARY OF THE DISCLOSURE

Various embodiments, aspects and features of the present invention encompass a new system of transmitting a variable bit rate (“VBR”) video content stream such as, but not limited to, an MPEG 2 transport stream, over a constant bit rate (“CBR”) network such as, but not limited to, an internet protocol (“IP”) network. As one of ordinary skill in the art will recognize, transmitting video streams over IP networks requires that the video streams not exceed a given bit threshold over a given period of time because, if a video stream exceeds the maximum level that can be transmitted over an interval, video packets may be dropped in lieu of transmission. The consequence is packet loss on the video stream, which causes pixilation, and interruption of the video stream upon display.

One embodiment for buffering the video stream to smooth out the variable bit rate in an MPEG 2 transport stream to a capped bit rate, while not causing packet loss on the network, and allowing the streams to pass through a bit rate constrained IP network, includes compressing a video content stream into a variable bit rate stream. The VBR stream may contain a series of frames for rendering at a given frame rate per second and each of the frames may be compressed such that data contained in each of the frames varies. The VBR stream may then be conditioned such that the frames are packed back to back into a constant bit rate stream that has associated with it a maximum bit quantity per unit time that may be transmitted. The packed video content stream, having a constant bit rate due to portions of the frames being packed into a given transmission segment, may be transmitted across a channel in a constant bit rate network.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1 is a diagram illustrating a variable bit rate (“VBR”) video content stream in the form of a group of pictures (“GOP”) containing an “I” frame and subsequent “P” and “B” frames;

FIG. 2 is a diagram illustrating the VBR video content stream of FIG. 1 after having been conditioned for transmission across a constant bit rate (“CBR”) network according to one embodiment of the system and method;

FIG. 3 is a functional block diagram illustrating an embodiment of a system for encoding a VBR video content stream in a bounded CBR IP network; and

FIG. 4 is a logical flowchart illustrating a method for conditioning a VBR video content stream for transmission across a CBR network.

### DETAILED DESCRIPTION

The word “exemplary” is used herein to mean “serving as an example, instance, or illustration.” Any aspect described herein as “exemplary” is not necessarily to be construed as exclusive, preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the term “display device” is used to describe any device suitable for rendering or displaying a video content. Therefore, a display device may be a television, a monitor, a gaming console, a personal computer, a cellular telephone, a satellite telephone, a pager, a PDA, a smartphone, a navigation device, a smartbook or reader, a media player, a combination of the aforementioned devices, a laptop computer with a wireless connection, among others.

In this description, the terms “pictures,” “frames” and “images” are used interchangeably to generally describe a still video content that forms a portion of a video content stream.

In this description, the term “bit” is used to describe a unit or quantity of data that may be transmitted across a network, whether such network be a “variable rate” network configured to transmit content streams having variable amounts of data per given unit of time or a “constant rate” network configured to transmit content streams having a constant amount of data per given unit of time. The terms “data” and “packet” are used interchangeably to reference content that may be measured in units of “bits.” As one of ordinary skill in the art will recognize, the bandwidth of a given transmission channel in a network may be constrained by a given amount of bits of data per unit of time and, as such, packets causing the bit rate to be exceeded may be truncated from a data stream.

Embodiments and aspects of the present invention provide a solution to the above-described need in the art, as well as other needs in the art, by generating a constant bit rate video content stream from a variable bit rate stream, such as an Mpeg 2 transport stream.

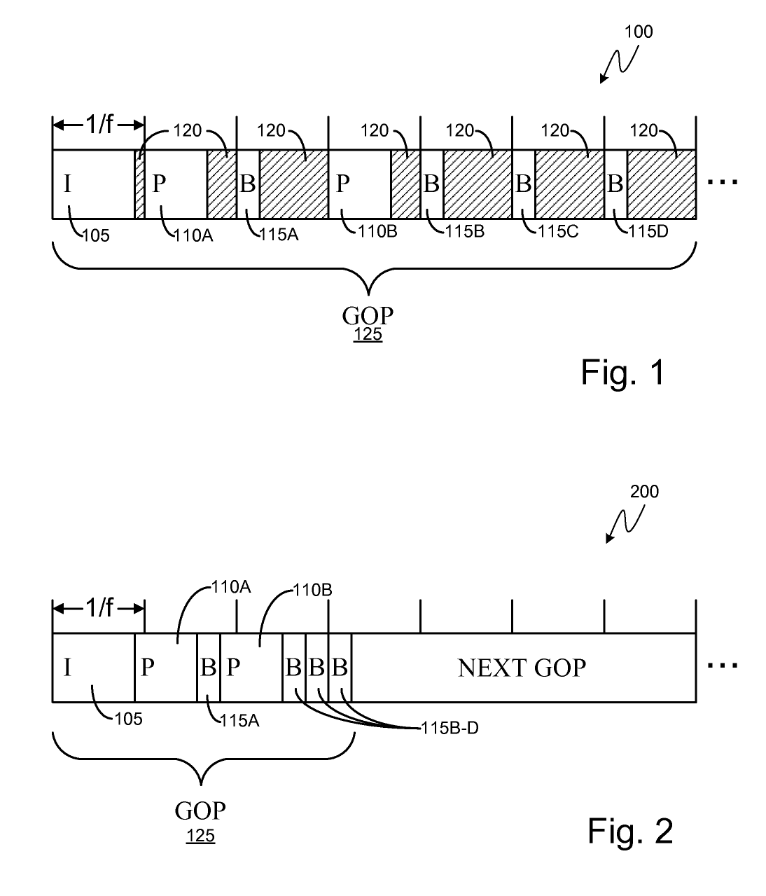

FIG. 1 is a diagram illustrating a variable bit rate (“VBR”) video content stream 100 in the form of a group of pictures (“GOP”) 125 containing an “I” frame 105 and subsequent “P” and “B” frames 110, 115. As can be seen in the FIG. 1 illustration, each of the frames 105, 110, 115 have been compressed such that excess bandwidth 120 exists within a given time 1/f. The “I” frame 105, being the lead frame in the exemplary GOP 125 contains the largest amount of data, relative to the other frames 110, 115. Leveraging data redundancies with the “I” frame 105, the “P” frames 110 have been compressed such that less packets are required to represent a given frame 110. Similarly, the “B” frames 115, further leveraging data redundancies have been compressed. Advantageously, by compressing the various frames, one of ordinary skill in the art will recognize that a variable bit rate content stream 100 is created such that bandwidth 120 is saved over a time “1/f” per frame transmission. Even so, one of ordinary skill in the art will also recognize that it is a disadvantage of a variable bit rate video content stream that it cannot be transmitted across a network channel that requires each frame 105, 110, 115 to contain an equal amount of data.

FIG. 2 is a diagram illustrating the VBR video content stream 100 of FIG. 1 after having been conditioned into a CBR content stream 200 suitable for efficient transmission across a constant bit rate network. As can be seen in the FIG. 2 diagram, the excess bandwidth associated with the “I” frame 105 has been utilized to send a first portion of the “P” frame 110A. In this way, the full bit capacity of the transmission channel in the constant bit rate network over the first segment of time “1/f” has been leveraged. Subsequently, the second segment of time “1/f” accommodates the transmission of the second portion of frame “P” 110A along with “B” frame 115A and the first portion of “P” frame 110B. In the exemplary content stream, the third segment of time “1/f” is leveraged to accommodate the transmission of the second portion of “P” frame 110B and each of “B” frames 115B, 115C. The fourth segment of time “1/f” is used to transmit “B” frame 115D before a next GOP 205 is transmitted in much the same manner.

Notably, although the exemplary conditioning methodology illustrated in FIG. 2 shows portions of more than one video content frame being compressed or packed for transmission during a period of time “1/f,” one of ordinary skill in the art will recognize that other embodiments of the methodology may be used to send only portions of a given frame across a channel over a time “1/f.” That is, because some VBR content streams may be generated for transmission across VBR networks largely unrestricted by bandwidth, a given frame within such a VBR stream may well exceed the maximum bit rate allowed by given constant bit rate network channel. In such cases, embodiments of the systems and methodologies may be used to condition the VBR stream such that only a portion of a given frame is transmitted per time “1/f” such that the bit rate maximum is not exceeded.

The novel methodology described and depicted relative to FIG. 2 can be analogized to a “leaky bucket.” The VBR bit stream from the Mpeg 2 transport stream flows into the bucket. However, the bucket is set up to allow a fixed bit rate to flow out of the bucket. This fixed output rate is one of the parameters of that must be met by the filter, or regulator, running the algorithm. Now since we are using rate control on the video stream that will achieve a guaranteed bit rate cap, and as a result the Mpeg 2 transport stream will have a guaranteed bit rate cap of, say br kbps, over some period of time, say t seconds—where t is generally the GOP size of the video stream. Because of this we know that if we set the output rate of the bucket to br kbps, and that the bucket is large enough, the bucket will never overflow. The size of the bucket is the second parameter of the algorithm. The size must be set large enough so that the bucket will not overflow, and as a result, cause the loss of video packets from being delivered to the network. Setting the bucket to br*t bits will result in a bucket that will never overflow—this can be seen since over t seconds the video encoder will produce a stream with no more than br*t bits, and over t seconds the bucket can output exactly br*t bits. Since the bucket has the same capacity, and the bucket is continually outputting bits, it will never overflow, although to be safe, one could certainly add a margin of safety when setting the parameters to the filter.

After the Mpeg 2 transport stream passes through this filter, the network packets being output to the network will be at an exact upper bound bit rate of br kbps. Because of this, the packets will be able to pass through the ip network with a lower bitrate than the methods described in the background as Case 2, or in using filler packets. This achieves the benefits of Case 1 rate control—higher quality video at a lower bit rate, and allows the stream to be delivered in a bitrate constrained network.

The tradeoff in using this approach is that it requires the video receiving apparatus, such as a Set Top Box or computer to buffer at least t seconds of the Mpeg 2 transport stream before attempting play the stream, to ensure that it always has enough bits to play, and does not cause the player architecture to underflow. The method for the playback apparatus is described in the next paragraph.

The playback apparatus needs to apply the inverse of the leaky bucket—rather like an upside down leaky bucket—which is essentially a video decoder that can be thought of as an inverse rate limited buffered input filter, where the constant bit rate network stream flows into the filter, and the normally timed mpeg 2 transport stream flows out of the bucket. The parameter to this filter is the size of the bucket for storage of the stream before any normal mpeg 2 transport stream packets will flow out of the filter, which we have mentioned should be at least t seconds (multiplied by br). Again, provided the stream gets into the input filter at the rate of br kbps, and we buffer for t seconds, the filter can return packets to the decoding application. The mpeg 2 demuxer would typically pull or request packets from the buffer in the filter according to the playback timestamps encoded in the stream. So long as the demuxer does not request packets faster than this, the buffer will remain at t seconds, and will not drain, allowing for normally, albeit slightly delayed, high quality, video playback.

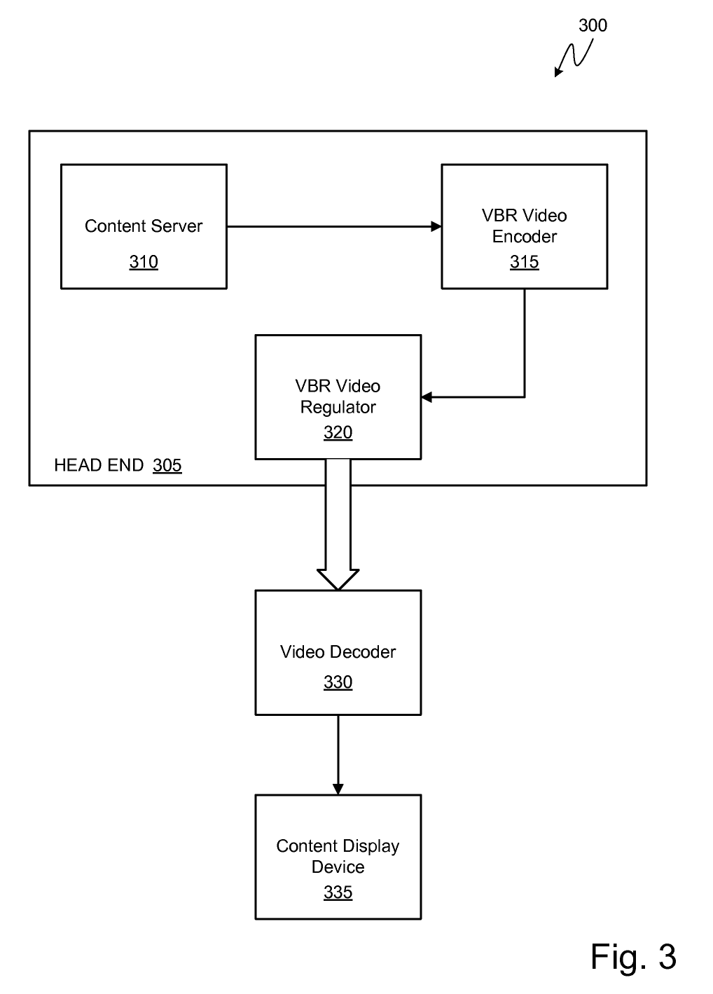

Turning to FIG. 3, a functional block diagram illustrating an embodiment of a system for encoding a VBR video content stream in a bounded CBR IP network is depicted. A head end 305 may contain a content server 310 and/or be in communication with any content source. The content server 310 may provide a video content stream to a variable bit rate encoder 315 which is configured to compress the video content stream into a VBR content stream according to a VBR algorithm. As one of ordinary skill in the art will understand, the content stream produced by the VBR video encoder 315 may resemble the content stream 100 depicted and described relative to FIG. 1. The VBR content stream may be provided to a VBR video regulator 320 that is configured to condition the VBR content stream into a constant bit rate content stream such as the stream described relative to FIG. 2.

The conditioned content stream may then be transmitted across a CBR network channel 325 and received at a video decoder 330. The video decoder 330 may be configured to decompress the conditioned CBR content stream generated by the regulator 320 such that the VBR content stream generated by encoder 315 is reconstructed. From the reconstructed VBR content stream, the video content originally provided by the content server 310 may be displayed on a content display device 335 such that each frame in the video content stream is displayed on the display device 335 in sequence and for a period equaling “1/f”.

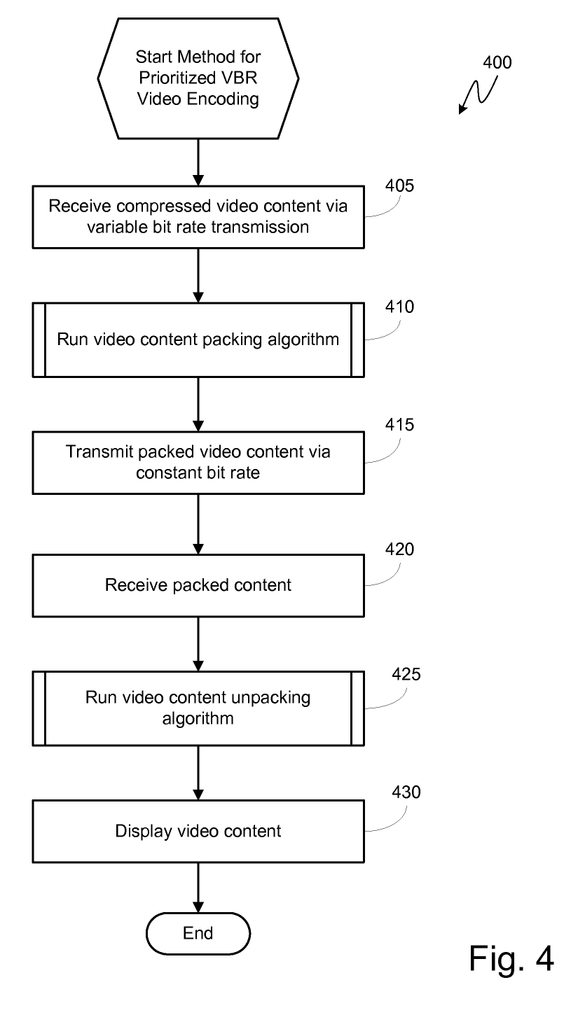

FIG. 4 is a logical flowchart illustrating a method 400 for conditioning a VBR video content stream for transmission across a CBR network. At block 405, a compressed video content may be received via a variable bit rate transmission. At routine block 410, a CBR conditioning algorithm according to previously described embodiments may be applied to the VBR content stream such that a “packed” video content stream approximating the exemplary stream of FIG. 2 is generated. At block 415, the packed video content stream may be transmitted across a constant bit rate network channel to a decoder device. The decoder device may receive the packed content stream at block 420 and run a decoding algorithm at block 425. As has been described and depicted, the decoding algorithm run at routine block 425 decompresses the packed video stream to regenerate the variable bit rate stream that can be displayed at block 430.

Various aspects, features and characteristics of the present invention have been described. Not all of the aspects, features or characteristics are required for each and every embodiment of the present invention. However, it will be appreciated that the various aspects, features, characteristics and combinations thereof may be considered novel in and of themselves.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the drawings, which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Therefore, although selected aspects have been illustrated and described in detail, it will be understood that various substitutions and alterations may be made therein without departing from the spirit and scope of the present invention, as defined by the following claims.

What is claimed is:

1. A method for conditioning a variable bit rate video content stream for transmission across a constant bit rate network channel, the method comprising:
compressing a video content stream into a variable bit rate stream, wherein:
the video content stream includes a series of frames for rendering at a given frame rate per second; and
the video content is compressed such that data contained in the frames varies;
conditioning the compressed video content stream by packing the frames of the compressed video content stream into a constant bit rate stream, wherein the constant bit rate stream dictates a maximum bit quantity per unit time that may be transmitted; and
transmitting the packed video content stream across a channel in a constant bit rate network.

2. The method of claim 1, wherein a portion of a frame from the compressed video content stream equals the maximum bit quantity that may be transmitted over a unit of time in the constant bit rate network.

3. The method of claim 1, wherein a portion of two or more frames from the compressed video content stream equals the maximum bit quantity that may be transmitted over a unit of time in the constant bit rate network.

4. The method of claim 1, further comprising:
receiving the packed video content stream at a decoder device;
decoding the packed video content stream to regenerate the compressed video content stream; and
displaying the video content stream on a display device.

5. The method of claim 1, wherein the constant bit rate network includes an asymmetric digital subscriber line channel.

6. A computer system for conditioning a variable bit rate video content stream for transmission across a constant bit rate network channel, the system comprising:
a variable bit rate video encoder configured to:
compress a video content stream into a variable bit rate stream, wherein:
the video content stream includes a series of frames for rendering
at a given frame rate per second; and
the video content is compressed such that data contained in the frames varies; and
a variable bit rate video regulator configured to:
condition the compressed video content stream by packing the frames of the compressed video content stream into a constant bit rate stream, wherein the constant bit rate stream dictates a maximum bit quantity per unit time that may be transmitted; and
transmit the packed video content stream across a channel in a constant bit rate network.

7. The computer system of claim 6, wherein a portion of a frame from the compressed video content stream equals the maximum bit quantity that may be transmitted over a unit of time in the constant bit rate network.

8. The computer system of claim 6, wherein a portion of two or more frames from the compressed video content stream equals the maximum bit quantity that may be transmitted over a unit of time in the constant bit rate network.

9. The computer system of claim 6, further comprising:
a video decoder configured to:
receive the packed video content stream;
decode the packed video content stream to regenerate the compressed video content stream; and
a display device configured to render the regenerated video content stream.

10. The computer system of claim 6, wherein the constant bit rate network includes an asymmetric digital subscriber line channel.

11. A computer system for conditioning a variable bit rate video content stream for transmission across a constant bit rate network channel, the system comprising:
means for compressing a video content stream into a variable bit rate stream, wherein:
the video content stream includes a series of frames for rendering at a given frame rate per second; and
the video content is compressed such that data contained in the frames varies;
means for conditioning the compressed video content stream by packing the frames of the compressed video content stream into a constant bit rate stream, wherein the constant bit rate stream dictates a maximum bit quantity per unit time that may be transmitted; and
means for transmitting the packed video content stream across a channel in a constant bit rate network.

12. The computer system of claim 11, wherein a portion of a frame from the compressed video content stream equals the maximum bit quantity that may be transmitted over a unit of time in the constant bit rate network.

13. The computer system of claim 11, wherein a portion of two or more frames from the compressed video content stream equals the maximum bit quantity that may be transmitted over a unit of time in the constant bit rate network.

14. The computer system of claim 11, further comprising:
means for receiving the packed video content stream at a decoder device;
means for decoding the packed video content stream to regenerate the compressed video content stream; and
means displaying the video content stream.

15. The computer system of claim 11, wherein the constant bit rate network includes an asymmetric digital subscriber line channel.
